(19) United States
(12) Patent Application Publication
(10) Pub. No.: US 2019/0227705 A1
(43) Pub. Date: Jul. 25, 2019

(54) METHOD FOR DISPLAYING USER INTERFACE OF APPLICATION AND ELECTRONIC DEVICE THEREOF

(71) Applicant: Samsung Electronics Co., Ltd., Suown-si (KR)

(72) Inventors: Chaekyung LEE, Suwon-si (KR); Hyun KIM, Suwon-si (KR); Joonwon PARK, Suwon-si (KR)

(21) Appl. No.: 16/256,551

(22) Filed: Jan. 24, 2019

(30) Foreign Application Priority Data
Jan. 24, 2018 (KR) 10-2018-0008769

(51) Int. Cl. G06F 3/0488; G06F 3/0484; G06F 3/0482; G06Q 20/34; G06Q 20/32

(52) U.S. Cl. CPC G06F 3/04883; G06F 3/04845; G06Q 20/40145; G06Q 20/353; G06Q 20/32; G06F 3/0482

(57) ABSTRACT

Various embodiments of the present disclosure provide an apparatus and a method for displaying a user interface of an application in an electronic device. The electronic device may include a display device comprising a display, at least one processor, and a memory electrically connected to the processor, wherein the memory may store instructions which, when executed by the processor, cause the electronic device to, if executing a first mode of an application, identify information regarding a second user interface corresponding to a second mode of the application, and to display a first user interface corresponding to the first mode, the first user interface including at least part of the second user interface, on the display device.

### CROSS-REFERENCE TO RELATED APPLICATION

This application is based on and claims priority under 35 U.S.C. § 119 to Korean Patent Application No. 10-2018-0008769, filed on Jan. 24, 2018, in the Korean Intellectual Property Office, the disclosure of which is incorporated by reference herein in its entirety.

### BACKGROUND

### 1. Field

The present disclosure relates generally to an apparatus and a method for displaying a user interface of an application in an electronic device.

### 2. Description of Related Art

With advances in information communication technology and semiconductor technology, various electronic devices may provide various services. For example, various services may include at least one of a voice call service, a message service, a broadcasting service, a wireless Internet service, a camera service, an electronic payment service, or a music play service.

To provide a service demanded by a user, the electronic device may install at least one application corresponding to the service. For example, applications installed on the electronic device may include at least one of a music application for playing user's intended music, a voice call application, a camera application, or an electronic payment application.

The electronic device may provide at least one user interface corresponding to the application, wherein the user uses the application. The application may include different user interfaces for respective modes. Hence, the user of the electronic device needs to execute a function corresponding to each mode using the different user interface per mode. For example, to use a function corresponding to a second mode while executing a first mode, the user of the electronic device may need to switch from a user interface corresponding to the first mode to a user interface corresponding to the second mode.

### SUMMARY

To address the above-discussed deficiencies of the prior art, it is an aspect of the present disclosure to provide an apparatus and a method for sharing at least part of a user interface corresponding to each mode in an electronic device.

According to an aspect of the present disclosure, an electronic device may include a display device comprising a display, at least one processor, and a memory electrically connected to the processor, wherein the memory may store instructions which, when executed by the processor, cause the electronic device to, if executing a first mode of an application, identify information regarding a second user interface corresponding to a second mode of the application, and to display a first user interface corresponding to the first mode which includes at least part of the second user interface on the display device.

According to another aspect of the present disclosure, a method for operating an electronic device may include executing a first mode of an application, identifying information regarding a second user interface corresponding to a second mode of the application, and displaying a first user interface corresponding to the first mode which includes at least part of the second user interface on a display device functionally connected to the electronic device.

According to yet another aspect of the present disclosure, a non-transitory computer-readable storage medium may store one or more programs for executing a first mode of an application, identifying information regarding a second user interface corresponding to a second mode of the application, and displaying a first user interface corresponding to the first mode which includes at least part of the second user interface on a display device functionally connected to the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a block diagram illustrating an electronic device for providing a user interface in a network environment according to various embodiments of the present disclosure;

FIG. 2 is a flowchart illustrating an example method of displaying a user interface in an electronic device according to various embodiments of the present disclosure;

FIGS. 3A, 3B, and 3C are diagrams illustrating example screen configurations for a user interface according to various embodiments of the present disclosure;

FIG. 4 is a flowchart illustrating an example method of displaying a user interface corresponding to a first mode in an electronic device according to various embodiments of the present disclosure;

FIGS. 5A, 5B, and 5C are diagrams illustrating example screen configurations for a user interface including a menu of other mode according to various embodiments of the present disclosure;

FIG. 6 is a flowchart illustrating an example method of displaying presence of new information of a menu in an electronic device according to various embodiments of the present disclosure;

FIG. 7 is a diagram illustrating an example screen configuration for a user interface including presence of new information according to various embodiments of the present disclosure;

FIG. 8 is a flowchart illustrating an example method of changing a menu layout of a user interface in an electronic device according to various embodiments of the present disclosure; and

FIGS. 9A, 9B, and 9C are diagrams illustrating example screen configurations for changing menu layout of a user interface in an electronic device according to various embodiments of the present disclosure.

Throughout the drawings, like reference numerals will be understood to refer to like parts, components and structures.

### DETAILED DESCRIPTION

Various example embodiments of the present disclosure are described below in greater detail with reference to the accompanying drawings. In describing an example embodiment of the present disclosure, related well-known functions or constructions may not be described in detail if they would obscure the gist of the present disclosure with unnecessary detail. The terms described below, which are terms defined considering functions of the present disclosure, may be modified according to user and operator's intention or practice, etc. Therefore, the definition should be given based on the content throughout the present disclosure.

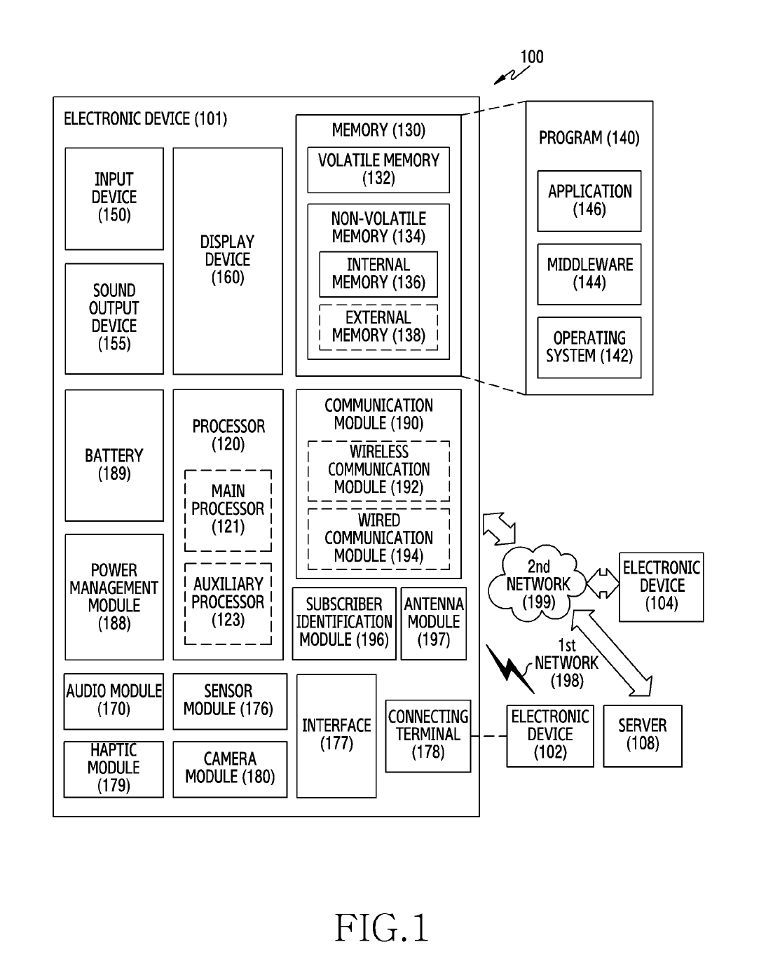

FIG. 1 is a block diagram illustrating an electronic device 101 for providing a user interface in a network environment 100 according to various embodiments.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120 and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by another component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150 or output the sound via the sound output device 155 or a headphone of an external electronic device (e.g., an electronic device 102) directly (e.g., wired) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector),

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as BLUETOOTH™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, and without limitation, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wired), wirelessly, or via a third element.

As used herein, the term “module” may include a unit implemented in hardware, software, and/or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PLAYSTORE™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

According to an embodiment, the processor 120 may control the memory 130 to store information regarding a user interface corresponding to an application. For example, if the application supports a plurality of modes, the processor 120 may control the memory 130 to store the user interface information corresponding to each mode. For example, the user interface information may be stored on the mode basis. The user interface information may include at least one of at least one menu in the user interface, menu position information, or menu use details. The menu use details may include at least one of time of the menu use, the number of menu uses, or a use period of a function corresponding to the menu. For example, the menu is an object corresponding to at least one function provided through the application and may be configured as an icon or a text. The processor 120 may execute at least one function corresponding to the menu based on a menu selection input.

According to an embodiment, if a configuration of the user interface is changed, the processor 120 may control the memory 130 to update the user interface information pre-stored. For example, the processor 120 may change a menu layout of a second user interface corresponding to a second mode, based on a user input detected through the input device 150. The processor 120 may control the memory 130 to update menu position information of the second user interface based on the menu layout change of the second user interface. For example, if executing a function corresponding to a first menu of the second user interface, the processor 120 may control the memory 130 to update the menu use details of the second user interface.

According to an embodiment, if executing a first mode of the application, the processor 120 may control the display device 160 to display a first user interface of the first mode. The first user interface may include at least part of the second user interface corresponding to the second mode of the application. For example, if executing the first mode of the application, the processor 120 may identify at least one menu to add to the first user interface among menus of the second user interface based on the user interface information stored in the memory 130. The processor 120 may control the display device 160 to display the first user interface including at least one menu of the second user interface. For example, the processor 120 may select at least one menu to add to the first user interface based on at least one of the position information or the use details of the menu of the second user interface.

According to an embodiment, the processor 120 may control the display device 160 to display presence of new information corresponding to the menu of the user interface. For example, if executing the first mode of the application, the processor 120 may identify whether there is new information corresponding to each menu of the first user interface from an external device (e.g., the server 108 of FIG. 1). The display device 160 may further display an icon indicating the new information on a menu having the new information among the menus of the first user interface. For example, the menus of the first user interface may include at least one menu displayed through the first user interface among the menus of the second user interface corresponding to the second mode of the application. For example, the processor 120 may periodically identify whether there is new information of the menu of the user interfaces from the external device (e.g., the server 108 of FIG. 1). For example, if receiving a check request message from the external device (e.g., the server 108 of FIG. 1), the processor 120 may identify new information of the menu of the user interface corresponding to the check request message from the external device (e.g., the server 108 of FIG. 1). For example, the new information may include information not identified by the user among function information corresponding to the menu.

According to various example embodiments of the present disclosure, an electronic device may include a display device comprising a display, at least one processor, and a memory electrically connected to the processor, wherein the memory may store instructions which, when executed by the processor, cause the electronic device to, if executing a first mode of an application, identify information regarding a second user interface corresponding to a second mode of the application, and to display a first user interface corresponding to the first mode which includes at least part of the second user interface, on the display device.

According to various example embodiments, the instructions may include instructions which, when executed by the at least one processor, cause the electronic device to display the first user interface corresponding to a payment mode of a payment application which includes at least part of the second user interface corresponding to a management mode of the payment application on the display device.

According to various example embodiments, the instructions may include instructions which, when executed by the at least one processor, cause the electronic device to, if executing the first mode of the application, identify information regarding the second user interface stored in the memory.

According to various example embodiments, the instructions may include instructions which, when executed by the at least one processor, cause the electronic device to, if the second user interface is updated, update the information regarding the second user interface stored in the memory, based on update information of the second user interface.

According to various example embodiments, the instructions may include instructions which, when executed by the at least one processor, cause the electronic device to select at least one menu to add to the first user interface from among at least one menu of the second user interface, based on the information regarding the second user interface, and to display the first user interface including the selected at least one menu on the display device.

According to various example embodiments, the instructions may include instructions which, when executed by the at least one processor, cause the electronic device to identify at least one menu disposed in a designated region of the second user interface, and to display the first user interface including the at least one menu disposed in the designated region on the display device.

According to various example embodiments, the information regarding the second user interface may include at least one of a menu of the second user interface, menu layout information, and/or menu use details.

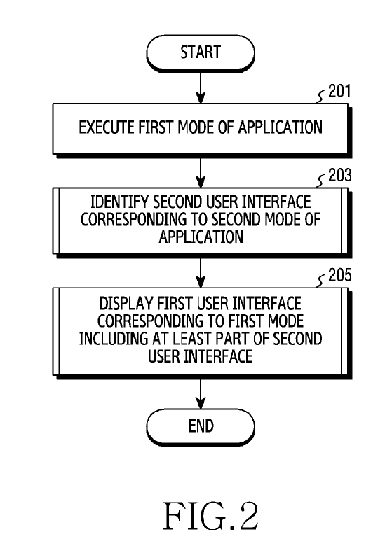

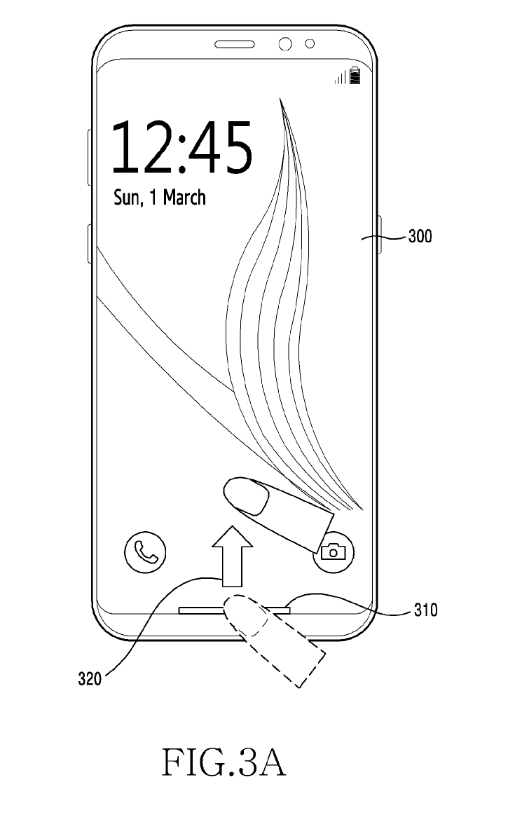

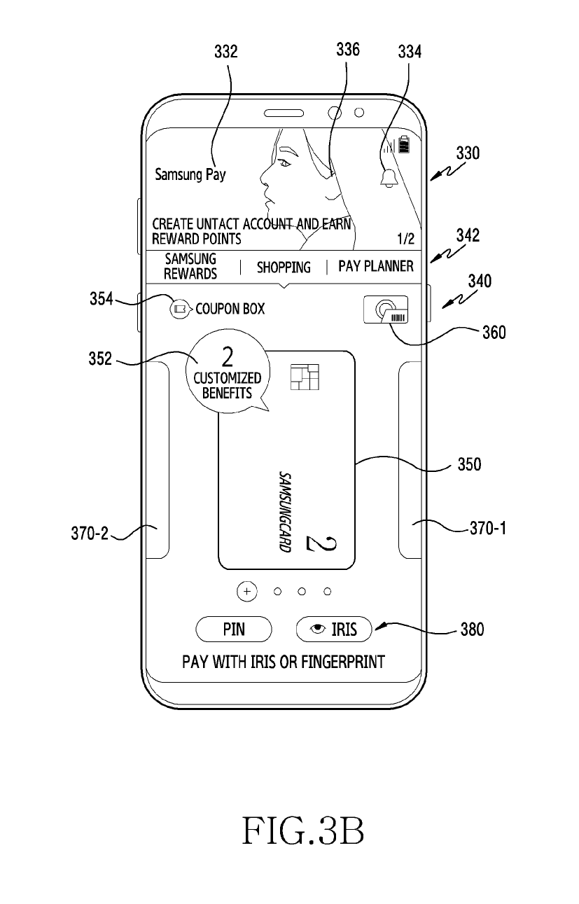

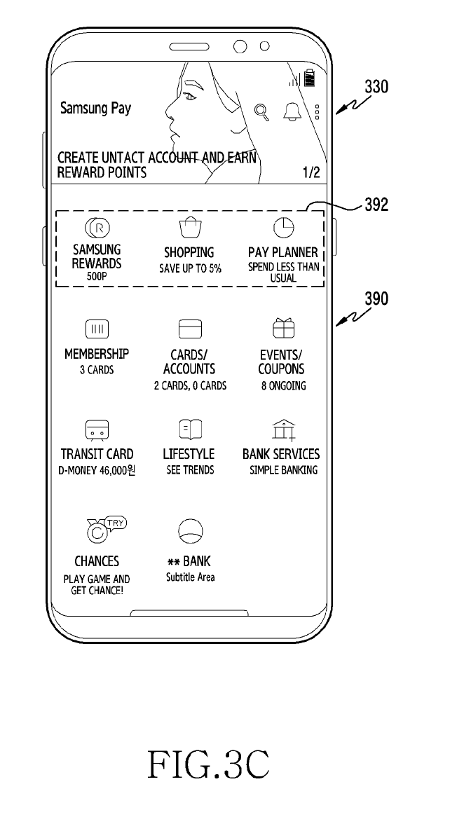

FIG. 2 is a flowchart illustrating an example method of displaying a user interface in an electronic device according to various embodiments of the present disclosure. FIGS. 3A, 3B, and 3C are diagrams illustrating example screen configurations for a user interface according to various embodiments of the present disclosure. Hereafter, the electronic device may include the electronic device 101 of FIG. 1 or at least part (e.g., the processor 120) of the electronic device 101.

Referring to FIG. 2, in operation 201, the electronic device may execute a first mode of an application. For example, the processor 120 may execute the first mode of the application corresponding to an icon where a user input (e.g., touch input) is detected among a plurality of icons displayed on the display device 160. For example, the first mode of the application may include a predefined operation mode of the application or an operation mode of the last application executed. For example, if receiving a gesture input corresponding to the first mode of the application through the input device 150, the processor 120 may execute the first mode of the application based on the gesture input.

For example, if executing a payment mode (the first mode) of a payment application (e.g., a standby screen 300), the processor 120 may control the display device 160 to display an icon 310 relating to the payment application in at least part of the display device 160 as shown in FIG. 3A. The icon 310 of the payment application may be displayed to indicate a position for the user's gesture to execute the payment application. If detecting a drag input 320 of a first direction (e.g., upward direction) corresponding to the display region of the icon 310 of the payment application, the processor 120 may execute the payment mode (the first mode) of the payment application. For example, the payment mode may include an operation mode for providing a payment service using at least one payment card registered in the payment application.

In operation 203, the electronic device may identify a second user interface corresponding to a second mode of the application. For example, as shown in FIG. 3A, if executing the payment mode (the first mode) of the payment application, the processor 120 may identify user interface information corresponding to a management mode (the second mode) of the payment application stored in the memory 130. For example, the user interface information may include at least one of at least one menu of the user interface, menu position information, and/or menu use details. For example, the management mode may include the payment mode as the operation mode for controlling the operations of the payment application.

In operation 205, the electronic device may display a first user interface corresponding to the first mode including at least part of the second user interface. For example, as shown in FIG. 3B, if executing the payment mode (the first mode) of the payment application, the processor 120 may control the display device 160 to display a user interface 340 corresponding to the payment mode including at least part 342 of the user interface corresponding to the management mode (the second mode) of the payment application. For example, the user interface 340 corresponding to the payment mode may include at least one menu 342 (e.g., Samsung Rewards, Shopping, and Pay Planner) of the management mode (the second mode) of the payment application in the at least part of the region. The user interface 340 corresponding to the payment mode may include at least one of payment card information 350 (e.g., an image) for the payment service, benefit information 352 (e.g., customized benefits) of the payment card, coupon information 354 (e.g., coupon box) available in the payment information, and/or user authentication information 380 (e.g., user authentication type selection menu, guide phrase (e.g., Pay with iris or fingerprint). The user interface 340 corresponding to the payment mode may include a membership card 360 registered in the payment application and/or other payment card information 370-1 and 370-2. For example, if receiving a user input (e.g., a swipe input) regarding the other payment card information 370-1, the processor 120 may change the payment card of the user interface 340 corresponding to the payment mode to a card corresponding to the other payment card information 370-1. For example, if receiving a user input regarding the membership card 360, the processor 120 may control the display device 160 to further display detailed information (e.g., barcode) of the membership card 360.

According to an embodiment, if executing the payment mode (the first mode) of the payment application, the electronic device 101 may display a user interface regarding an event of the payment information in at least part of the display device 160. For example, the processor 120 may control the display device 160 to display a user interface 330 regarding the event of the payment information in a different display region from the user interface 340 corresponding to the payment mode. For example, the user interface 330 regarding the event of the payment information may include at least one of a management mode switch icon 332, a new information icon 334, and/or event information 336 provided in the payment application. The new information icon 334 may indicate presence or absence of new information regarding the payment application. The management mode switch icon 332 may include a function for switching the operation mode of the payment application to the management mode based on a user's selection input.

For example, if receiving a user input regarding the management mode switch icon 332, the processor 120 may control the display device 160 to display a user interface 390 corresponding to the management mode of the payment application as shown in FIG. 3C. The user interface 330 regarding the event of the payment information may be displayed in at least part of the display device 160 as shown in FIG. 3C, even in the management mode of the payment application.

According to an embodiment, the electronic device 101 may determine a menu to add to the user interface of the payment mode based on at least one of the menu position or the use details in the user interface corresponding to the management mode (the second mode) of the payment application. For example, as shown in FIG. 3C, the processor 120 may select the menus of Samsung Rewards, Shopping, and Pay planner disposed in a first region 392 of the user interface 390 corresponding to the management mode of the payment application, as the menus to add to the user interface 340 of the payment mode.

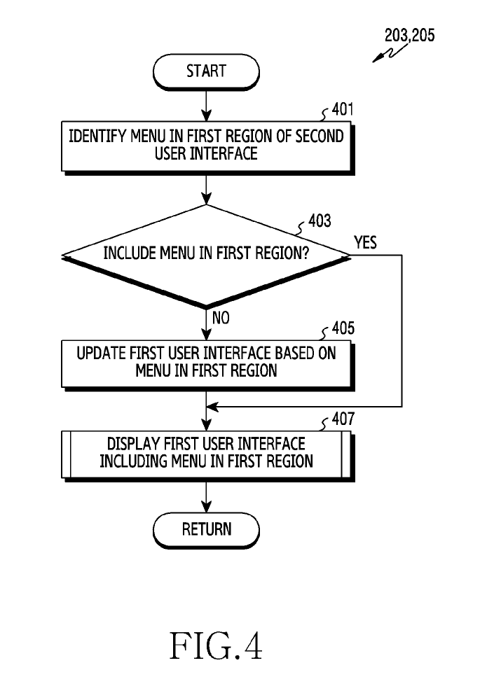

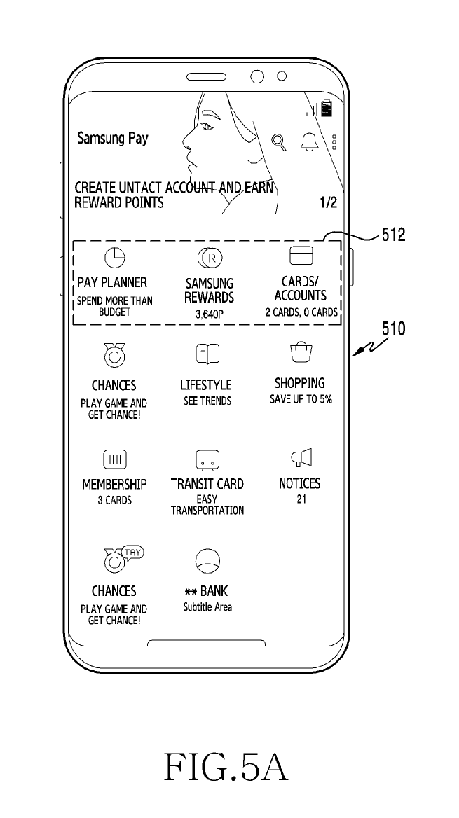

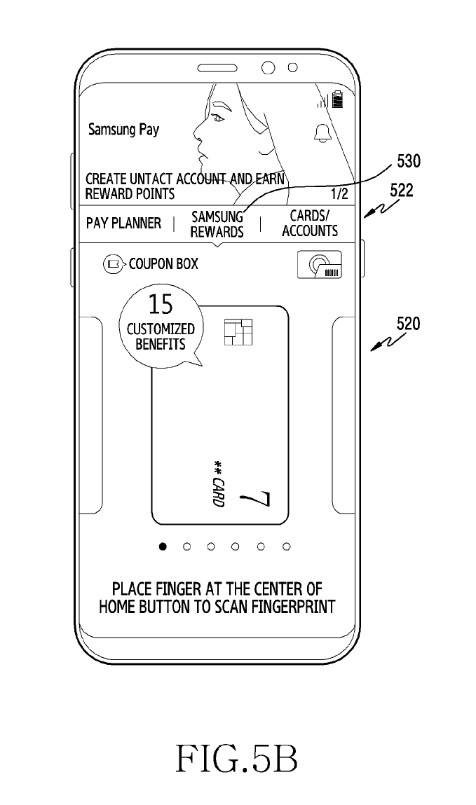

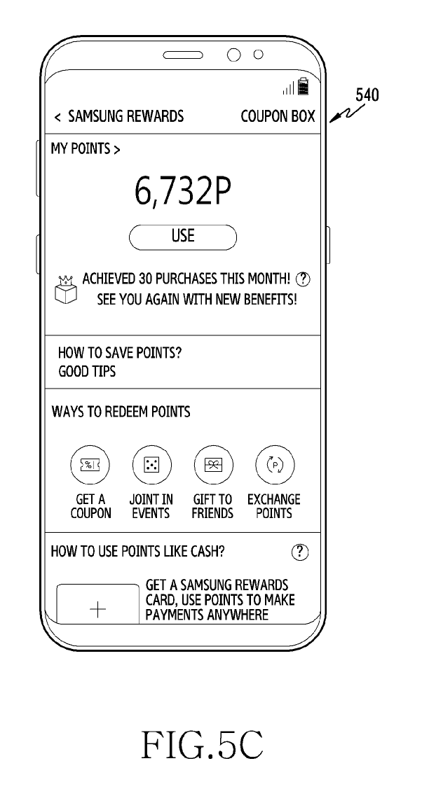

FIG. 4 is a flowchart illustrating an example method of displaying a user interface corresponding to a first mode in an electronic device according to various embodiments of the present disclosure. FIGS. 5A, 5B, and 5C are diagrams illustrating example screen configurations for a user interface including a menu of other mode according to various embodiments of the present disclosure. The following describes displaying the user interface corresponding to the first mode of the application of operation 203 and operation 205 of FIG. 2. Hereafter, the electronic device may include the electronic device 101 of FIG. 1 or at least part (e.g., the processor 120) of the electronic device 101.

Referring to FIG. 4, in operation 401, if executing a first mode of an application (e.g., operation 201 of FIG. 2), the electronic device may identify a menu disposed in a first region of a second user interface corresponding to a second mode of the application. For example, the processor 120 may identify the menu disposed in the first region (e.g., the top region) of the second user interface corresponding to the second mode based on user interface information (e.g., menu layout information) relating to the application stored in the memory 130. For example, the first region may include a preset region for selecting the menu to display in other user interface.

In operation 403, the electronic device may identify whether a first user interface corresponding to the first mode includes at least one menu disposed in the first region of the second user interface corresponding to the second mode. For example, the processor 120 may identify whether at least one menu disposed in the first region of the second user interface corresponding to the second mode is changed. For example, if the menu layout of the first region of the second user interface is changed, the processor 120 may determine that the first user interface does not include the at least one menu disposed in the first region of the second user interface. For example, if the menu layout of the first region of the second user interface is maintained, the processor 120 may determine that the first user interface includes the at least one menu disposed in the first region of the second user interface. For example, the menu layout of the first region may include at least one of a menu position change in the first region or a menu type change in the first region.

If the first user interface does not include the at least one menu disposed in the first region of the second user interface, the electronic device may update the first user interface corresponding to the first mode to include the at least one menu disposed in the first region in operation 405.

If the first user interface includes the at least one menu disposed in the first region of the second user interface or if the first user interface is updated to include the at least one menu disposed in the first region, the electronic device may display the first user interface corresponding to the first mode including the at least one menu disposed in the first region in operation 407.

For example, a first user interface 510 corresponding to the management mode (the second mode) of the payment application may include Pay planner, Samsung Rewards, and Cards/Accounts menus in a first region 512 as shown in FIG. 5A. A second user interface 520 corresponding to the payment mode (the first mode) may include Pay planner, Samsung Rewards, and Cards/Accounts menus 522 of the first region 512 of the first user interface 510 as shown in FIG. 5B.

According to an embodiment, if receiving a selection input of a menu (e.g., Samsung Rewards) 530 of the first user interface 510 in the second user interface 520 displayed on the display device 160, as shown in FIG. 5B, the electronic device 101 may execute a function corresponding to the menu 530. For example, the electronic device 101 may display a user interface 540 of the function corresponding to the Samsung Rewards menu 530 on the display device 160 as shown in FIG. 5C. If receiving a backward user input, the electronic device 101 may display the second user interface 520 on the display device 160 as shown in FIG. 5B.

According to various embodiments of the present disclosure, the electronic device 101 may select at least one menu to add to the user interface corresponding to the first mode based on menu use details of the user interface corresponding to the second mode of the application. For example, the processor 120 may select at least one menu to add to the user interface corresponding to the payment mode (the first mode) based on at least one of the number of menu uses or the menu use time of the user interface corresponding to the management mode (the second mode) of the payment application. For example, the processor 120 may determine at least one menu which is used most frequently during a reference time based on current time, as the at least one menu to add to the user interface corresponding to the payment mode (the first mode).

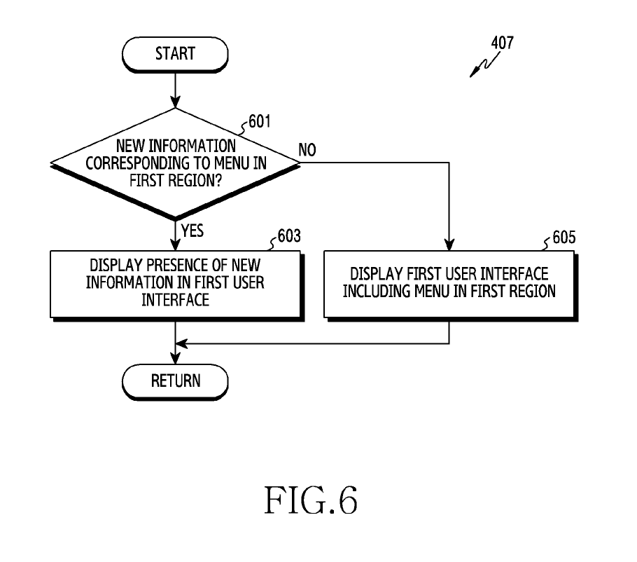

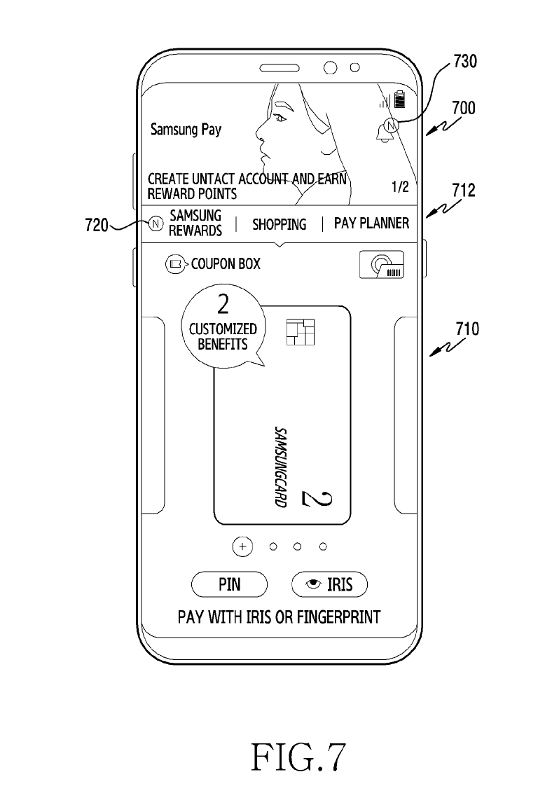

FIG. 6 is a flowchart illustrating an example method of displaying presence of new information of a menu in an electronic device according to various embodiments of the present disclosure. FIG. 7 is a diagram illustrating an example screen configuration for a user interface including presence of new information according to various embodiments of the present disclosure. The following explains displaying the user interface corresponding to the first mode of the application in operation 407 of FIG. 4. In the following, the electronic device may include the electronic device 101 of FIG. 1 or at least part (e.g., the processor 120) of the electronic device 101.

Referring to FIG. 6, if identifying a first user interface corresponding to the first mode of the application to display in the display device 160 (e.g., operation 405 of FIG. 4), the electronic device may identify whether there is new information corresponding to at least one menu disposed in a first region of a second user interface in operation 601.

For example, the processor 120 may identify whether there is new information corresponding to each menu disposed in the first region of the second user interface corresponding to the management mode (the second mode) from an external device (e.g., the server 108 of FIG. 1) at the payment mode (the first mode) execution of the payment application. For example, the processor 120 may periodically identify whether there is new information of the menu of the user interface stored in the memory 130 from the external device (e.g., the server 108 of FIG. 1). The processor 120 may add presence or absence of the new information of each menu to user interface information stored in the memory 130. For example, if receiving a check request message from the external device (e.g., the server 108 of FIG. 1), the processor 120 may identify new information of a menu of a user interface corresponding to the check request message from the external device (e.g., the server 108 of FIG. 1).

In response to the new information corresponding to at least one menu disposed in the first region of the second user interface added to the first user interface, the electronic device may display the first user interface indicating the presence of the new information corresponding to the menu in operation 603.

For example, if executing the payment mode (the first mode) of the payment application, the processor 120 may control the display device 160 to display a user interface 710 corresponding to the payment mode as shown in FIG. 7. The user interface 710 corresponding to the payment mode may include Samsung Rewards, Shopping, and Pay Planner menus disposed in a first region (e.g., the top region) of the second user interface corresponding to the management mode (the second mode), in at least some region 712. In response to new information corresponding to the Samsung Rewards menu, the processor 120 may control the display device 160 to display the presence of the new information 720 in the Samsung Rewards menu as shown in FIG. 7.

In response to no new information corresponding to at least one menu disposed in the first region of the second user interface added to the first user interface, the electronic device may display the first user interface including at least one menu disposed in the first region of the second user interface in operation 605.

According to an embodiment, in response to the new information corresponding to at least one menu disposed in the first region of the second user interface added to the first user interface, the electronic device 101 may display the presence of the new information in a user interface regarding an event of the payment application. For example, in response to new information corresponding to the Samsung Rewards menu, a user interface 700 regarding the event of the payment application may display presence of the new information regarding the payment application at a new information icon 730 as shown in FIG. 7.

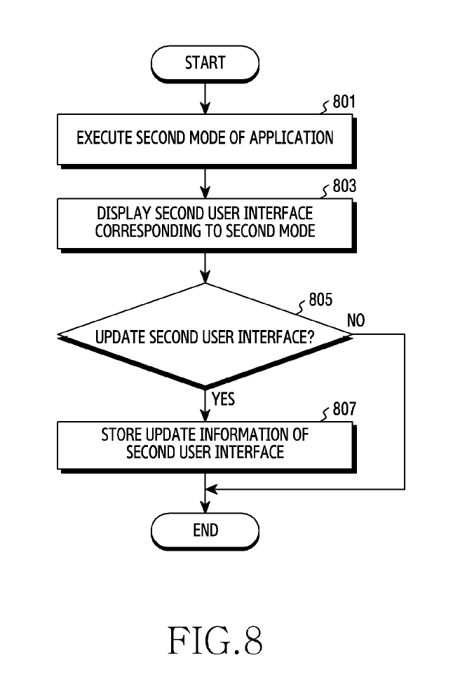

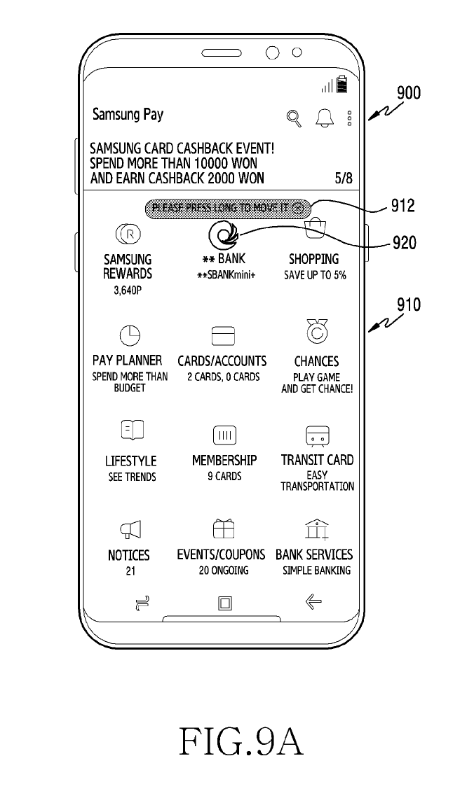

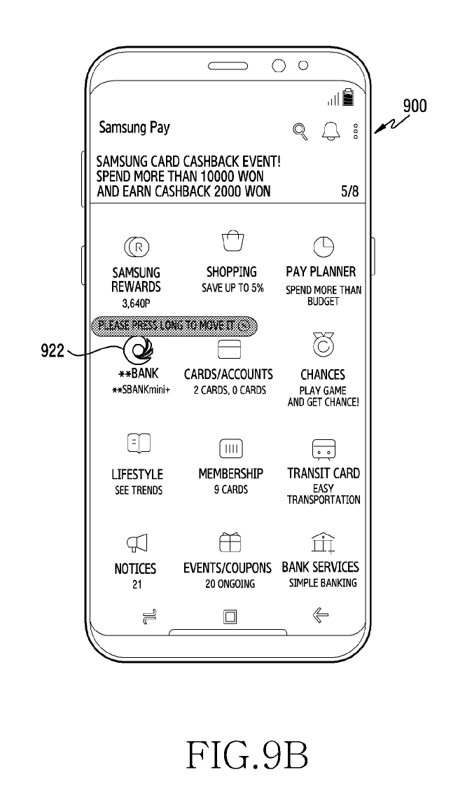

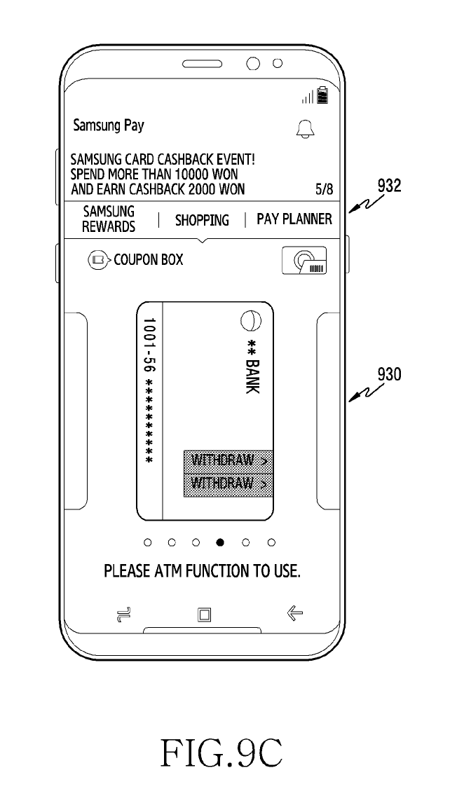

FIG. 8 is a flowchart illustrating an example method of changing menu layout of a user interface in an electronic device according to various embodiments of the present disclosure. FIGS. 9A, 9B, and 9C are diagrams illustrating example screen configurations for changing menu layout in a user interface according to various embodiments of the present disclosure. In the following, the electronic device may include the electronic device 101 of FIG. 1 or at least part (e.g., the processor 120) of the electronic device 101.

Referring to FIG. 8, in operation 801, the electronic device may execute a second mode of an application. For example, if receiving a user input (e.g., a touch input) corresponding to an icon regarding the payment application among a plurality of icons displayed on the display device 160, the processor 120 may execute the management mode (second mode) of the payment application. For example, if receiving a user input corresponding to the management mode switch icon 332 in the user interface 330 regarding the event of the payment application as shown in FIG. 3B, the processor 120 may execute the management mode (the second mode) of the payment application.

In operation 803, the electronic device may display a second user interface corresponding to the second mode of the application. For example, if executing the management mode (the second mode) of the payment application, the processor 120 may obtain user interface information regarding the management mode of the payment application from the memory 130. The processor 120 may control the display device 160 to display the second user interface corresponding to the management mode of the payment application based on the user interface information obtained from the memory 130.

For example, a user interface 910 corresponding to the management mode may include a menu corresponding to at least one function of the payment application. The user interface 910 corresponding to the management mode may display a guide phrase 912 (e.g., “Please Press Long to Move It”) regarding the menu. For example, if executing the payment mode (the first mode) of the payment application, the processor 120 may control the display device 160 to display a user interface 900 regarding the event of the payment application in at least part of the display device 160.

In operation 805, the electronic device may identify whether a configuration of the second user interface corresponding to the second mode of the application is changed. For example, the processor 120 may identify whether the menu layout of the second user interface corresponding to the second mode is changed, based on a user input received through the input device 150.

For example, if a user input to a particular menu (e.g., ** bank menu 920) is maintained for a designated time in the user interface 910 corresponding to the management mode (the second mode) as shown in FIG. 9A, the processor 120 may determine occurrence of an update event regarding the user interface 910. In response to the update event, the processor 120 may update the menu layout 922 of the user interface 910 corresponding to the management mode (the second mode) as shown in FIG. 9B, based on position change information of the particular menu of the maintained user input.

If the configuration of the second user interface corresponding to the second mode of the application is changed, the electronic device may update information regarding the second user interface stored in the memory in operation 807.

According to an embodiment, if the menu layout of the user interface corresponding to the management mode (the second mode) is changed as shown in FIG. 9B, the electronic device may change at least one menu 932 included in a user interface 930 corresponding to the payment mode (the first mode) as shown in FIG. 9C. For example, the user interface 930 corresponding to the payment mode (the first mode) may include Samsung Rewards, Shopping, and Pay planner menus disposed in a first region of the user interface corresponding to the management mode (the second mode), based on the update information of the user interface corresponding to the management mode.

According to various embodiments of the present disclosure, if executing the first application, the electronic device 101 may display the user interface of the first application including at least part of the user interface of the second application in relation to the first application, in the display device 160.

As set forth above, an electronic device and its operating method according to various embodiments may enable the user of the electronic device to easily execute a function of a different mode, by adding at least part of the user interface corresponding to the first mode to the user interface corresponding to the second mode.

According to various example embodiments of the present disclosure, a method for operating an electronic device may include executing a first mode of an application, identifying information regarding a second user interface corresponding to a second mode of the application, and displaying a first user interface corresponding to the first mode which includes at least part of the second user interface on a display device functionally connected to the electronic device.

According to various example embodiments, displaying the first user interface may include displaying the first user interface corresponding to a payment mode of a payment application which includes at least part of the second user interface corresponding to a management mode of the payment application on the display device.

According to various example embodiments, identifying the information regarding the second user interface may include, if executing the first mode of the application, identifying information regarding the second user interface stored in a memory functionally connected to the electronic device.

According to various example embodiments, the method may further include, if the second user interface is updated, updating the information regarding the second user interface stored in the memory, based on update information of the second user interface.

According to various example embodiments, displaying the first user interface may include selecting at least one menu to add to the first user interface from among at least one menu of the second user interface, based on the information regarding the second user interface, and displaying the first user interface including the selected at least one menu, on the display device.

According to various example embodiments, selecting the at least one menu to add to the first user interface may include identifying at least one menu disposed in a designated region of the second user interface.

According to various example embodiments, the information regarding the second user interface may include at least one of a menu of the second user interface, menu layout information, and menu use details.

According to various example embodiments of the present disclosure, a non-transitory computer-readable storage medium may store one or more programs for executing a first mode of an application, identifying information regarding a second user interface corresponding to a second mode of the application, and displaying a first user interface corresponding to the first mode which includes at least part of the second user interface on a display device functionally connected to the electronic device.

According to various example embodiments, displaying the first user interface may include displaying the first user interface corresponding to a payment mode of a payment application which includes at least part of the second user interface corresponding to a management mode of the payment application on the display device.

According to various example embodiments, identifying the information regarding the second user interface may include, if executing the first mode of the application, identifying information regarding the second user interface stored in a memory functionally connected to the electronic device.

According to various example embodiments, the one or more programs may further, if the second user interface is updated, update the information regarding the second user interface stored in the memory, based on update information of the second user interface.

According to various example embodiments, displaying the first user interface may include selecting at least one menu to add to the first user interface among at least one menu of the second user interface, based on the information regarding the second user interface, and displaying the first user interface including the selected at least one menu, on the display device.

According to various example embodiments, selecting the at least one menu to add to the first user interface may include identifying at least one menu disposed in a designated region of the second user interface.

Although the present disclosure has been illustrated and described with reference to various example embodiments, various changes and modifications may be apparent to one skilled in the art. It is intended that the present disclosure encompass such changes and modifications as fall within the scope of the appended claims.

What is claimed is:

1. An electronic device comprising:
a display device comprising a display;
at least one processor; and
a memory electrically connected to the processor,
wherein the memory stores instructions which, when executed by the at least one processor, cause the electronic device to:
if executing a first mode of an application, identify information regarding a second user interface corresponding to a second mode of the application, and
display a first user interface corresponding to the first mode, the first user interface comprising at least part of the second user interface, on the display device.

2. The electronic device of claim 1, wherein the instructions including instructions which, when executed by the at least one processor, cause the electronic device to:
display the first user interface, the first user interface corresponding to a payment mode of a payment application, the first user interface comprising at least part of the second user interface, the second user interface corresponding to a management mode of the payment application, on the display device.

3. The electronic device of claim 1, wherein the instructions comprise instructions which, when executed by the at least one processor, cause the electronic device to:
if executing the first mode of the application, identify information regarding the second user interface stored in the memory.

4. The electronic device of claim 3, wherein the instructions comprise instructions which, when executed by the at least one processor, cause the electronic device to:
if the second user interface is updated, update the information regarding the second user interface stored in the memory based on update information of the second user interface.

5. The electronic device of claim 1, wherein the instructions comprise instructions which, when executed by the at least one processor, cause the electronic device to:
select at least one menu to add to the first user interface from among at least one menu of the second user interface based on the information regarding the second user interface, and
display the first user interface comprising the selected at least one menu on the display device.

6. The electronic device of claim 5, wherein the instructions comprise instructions which, when executed by the at least one processor, cause the electronic device to:
identify at least one menu disposed in a designated region of the second user interface, and
display the first user interface comprising the at least one menu disposed in the designated region on the display device.

7. The electronic device of claim 1, wherein the information regarding the second user interface comprises at least one of: a menu of the second user interface, menu layout information, and menu use details.

8. A method for operating an electronic device, comprising:
executing a first mode of an application;
identifying information regarding a second user interface corresponding to a second mode of the application; and
displaying a first user interface corresponding to the first mode of the application, the first user interface comprising at least part of the second user interface, on a display device functionally connected to the electronic device.

9. The method of claim 8, wherein displaying the first user interface comprises:
displaying the first user interface, the first user interface corresponding to a payment mode of a payment application, the first user interface comprising at least part of the second user interface, the second user interface corresponding to a management mode of the payment application, on the display device.

10. The method of claim 8, wherein identifying the information regarding the second user interface comprises:
if executing the first mode of the application, identifying information regarding the second user interface stored in a memory functionally connected to the electronic device.

11. The method of claim 8, further comprising:
if the second user interface is updated, updating the information regarding the second user interface stored in the memory based on update information of the second user interface.

12. The method of claim 8, wherein displaying the first user interface comprises:
selecting at least one menu to add to the first user interface from among at least one menu of the second user interface based on the information regarding the second user interface; and
displaying the first user interface comprising the selected at least one menu on the display device.

13. The method of claim 12, wherein selecting the at least one menu to add to the first user interface comprises:
identifying at least one menu disposed in a designated region of the second user interface.

14. The method of claim 8, wherein the information regarding the second user interface comprises at least one of: a menu of the second user interface, menu layout information, and menu use details.

15. A non-transitory computer-readable storage medium having stored thereon one or more programs, which when executed by a processor, cause an electronic device to perform operations comprising:
executing a first mode of an application;
identifying information regarding a second user interface corresponding to a second mode of the application; and
displaying a first user interface corresponding to the first mode of the application, the first user interface comprising at least part of the second user interface, on a display device functionally connected to the electronic device.

16. The non-transitory computer-readable storage medium of claim 15, wherein displaying the first user interface comprises:
displaying the first user interface, the first user interface corresponding to a payment mode of a payment application, the first user interface comprising at least part of the second user interface, the second user interface corresponding to a management mode of the payment application, on the display device.

17. The non-transitory computer-readable storage medium of claim 15, wherein identifying the information regarding the second user interface comprises:
if executing the first mode of the application, identifying information regarding the second user interface stored in a memory functionally connected to the electronic device.

18. The non-transitory computer-readable storage medium of claim 15, wherein the operations further comprise: if the second user interface is updated, updating the information regarding the second user interface stored in the memory, based on update information of the second user interface.

19. The non-transitory computer-readable storage medium of claim 15, wherein displaying the first user interface comprises:
selecting at least one menu to add to the first user interface from among at least one menu of the second user interface based on the information regarding the second user interface; and
displaying the first user interface comprising the selected at least one menu on the display device.

20. The non-transitory computer-readable storage medium of claim 19, wherein selecting the at least one menu to add to the first user interface comprises:
identifying at least one menu disposed in a designated region of the second user interface.
